(19) United States
(12) Patent Application Publication
(10) Pub. No.: US 2025/0265935 A1
(43) Pub. Date: Aug. 21, 2025

(54) APPARATUSES, COMPUTER-IMPLEMENTED METHODS, AND COMPUTER PROGRAM PRODUCTS FOR LANDING DISTANCE PREDICTION

(71) Applicant: Honeywell International Inc., Charlotte, NC (US)

(72) Inventor: Ye He, Shanghai (CN)

(21) Appl. No.: 18/583,317

(22) Filed: Feb. 21, 2024

(51) Int. Cl. G08G 5/02; G08G 5/00

(52) U.S. Cl. CPC G08G 5/54; G08G 5/22

(57) ABSTRACT

Embodiments of the disclosure provide for improved landing distance prediction. In the context of a method, the method includes generating an runway condition associated with a runway based on sensor data; retrieving a stored runway model based on the runway condition; generating, using the retrieved runway model, a predicted landing distance for a vehicle based on real-time vehicle data for the vehicle; and providing to the vehicle a historical true landing distance and a historical predicted landing distance for another vehicle and the predicted landing distance for the vehicle to cause the vehicle to: generate a compensation factor based on the historical true and predicted landing distances; generate a second predicted landing distance for the vehicle based on the real-time vehicle data; and generate a weighted landing distance based on the predicted landing distance for the vehicle, the second predicted landing distance, and the compensation factor.

### TECHNOLOGICAL FIELD

Embodiments of the present disclosure are generally directed to predicting a landing distance for a vehicle.

### BACKGROUND

Typical approaches to predicting landing distance for a vehicle rely upon vehicle performance data and runway conditions. For example, a runway condition may be associated with a predefined value for use in landing distance prediction when said condition is present on the target runway. However, the predefined value may be inaccurate when the same or additional runway conditions deviate from the fixed definition based upon which the predefined value was establish. As a result, predicted landing distances may deviate from true landing distances due to inability of the prediction model to capture all factors and interactions thereof that may influence landing distance.

Applicant has discovered various technical problems associated with accurately predicting landing distance for a vehicle. Through applied effort, ingenuity, and innovation, Applicant has solved many of these identified problems by developing the embodiments of the present disclosure, which are described in detail below.

### BRIEF SUMMARY

In general, embodiments of the present disclosure herein provide for prediction of weighted landing distances based at least in part on compensation factors that capture historical differences in predicted and true landing distances. For example, embodiments of the present disclosure provide for providing historical true and predicted landing distances to a vehicle to cause the vehicle to generate a compensation factor. Further, predicted landing distances may be generated by and provided to the vehicle to cause the vehicle to generate a weighted landing distance based at least in part on the predicted landing distance generated by the vehicle and the second predicted landing distance received by the vehicle from a ground station. The vehicle may apply the compensation factor to the second predicted landing distance to control contribution of the second predicted landing distance to the weighed landing distance computation, thereby controlling for the historical offset in true versus predicted landing distances. Other implementations for predicting landing distance will be, or will become, apparent to one with skill in the art upon examination of the following figures and detailed description. It is intended that all such additional implementations be included within this description be within the scope of the disclosure, and be protected by the following claims.

In accordance with a first aspect of the disclosure, a computer-implemented method for improved landing prediction is provided. The computer-implemented method is executable utilizing any of a myriad of computing device(s) and/or combinations of hardware, software, firmware. In some example embodiments an example computer-implemented method includes generating, at a ground station, at least one runway condition associated with a runway based at least in part on sensor data from at least one sensor; retrieving, at the ground station, one of a plurality of stored runway models based at least in part on the at least one runway condition; generating, at the ground station and using the retrieved runway model, a predicted landing distance for an approaching vehicle upon the runway based at least in part on model input comprising real-time vehicle data for the approaching vehicle; and providing, from the ground station to the approaching vehicle, a historical true landing distance for at least one vehicle, a historical predicted landing distance for the at least one vehicle, and the predicted landing distance for the approaching vehicle to cause the approaching vehicle to: generate a compensation factor based at least in part on the historical true landing distance for the at least one vehicle and the historical predicted landing distance for the at least one vehicle; generate a second predicted landing distance for the approaching vehicle based at least in part on the real-time vehicle data for the approaching vehicle; and generate a weighted landing distance based at least in part on the predicted landing distance for the approaching vehicle, the second predicted landing distance, and the compensation factor.

In some embodiments, the method further includes obtaining, at the ground station, a true landing distance of the approaching vehicle upon the runway; and storing, at the ground station, the true landing distance of the approaching vehicle in association with the predicted landing distance for the approaching vehicle. In some embodiments, the ground station receives the true landing distance of the approaching vehicle from the approaching vehicle. In some embodiments, the method further includes receiving, at the ground station, additional real-time vehicle data for the approaching vehicle during landing, wherein the ground station generates the true landing of the approaching vehicle based at least in part on the additional real-time vehicle data.

In some embodiments, the method further includes receiving, at the ground station, the real-time vehicle data for the approaching vehicle from at least one flight monitoring system of the approaching vehicle. In some embodiments, the method further includes obtaining, at the ground station, the historical true landing distance for the at least one vehicle; and storing, at the ground station, the historical true landing distance in association with the historical predicted landing distance for the at least one vehicle upon the runway. In some embodiments, the method further includes determining at least one classification of the approaching vehicle matches at least one classification of the at least one vehicle; and in response to the determination, providing the historical true landing distance and the historical predicted distance for the at least one vehicle to the approaching vehicle.

In some embodiments, a respective true landing distance corresponds to a length of a runway used by a vehicle to land upon the runway; and the historical true landing distance is obtained by the ground station from the at least one vehicle. In some embodiments, the method further includes causing an autopilot system of the approaching vehicle to control the approaching vehicle based at least in part on at least one of the compensation factor or the weighted landing distance. In some embodiments, the at least one runway condition comprises at least one precipitation condition associated with the runway.

In some embodiments, the at least one precipitation condition comprises at least one of snow, ice, or frost. In some embodiments, the at least one precipitation condition comprises snow compaction. In some embodiments, the at least one runway condition comprises at least one wind condition associated with the runway. In some embodiments, the at least one runway condition comprises runway visual range. In some embodiments, the at least one runway condition comprises runway elevation.

In some embodiments, the method further comprises receiving at least one of the compensation factor, the weighted landing distance, or a true landing distance from the approaching vehicle; and storing at least one of the compensation factor, the weighted landing distance, or the true landing distance in association with at least one of the historical predicted landing distance for the at least one vehicle or the predicted landing distance for the at least one vehicle. In some embodiments, the method further comprises updating a respective runway model based at least in part on at least one of the compensation factor, the weighted landing distance, or the true landing distance. In some embodiments, the method further includes receiving the weighted landing distance from the approaching vehicle; and instructing the approaching vehicle to land on a second runway based at least in part on the weighted landing distance.

In accordance with another aspect of the present disclosure, a computing apparatus for improved landing distance prediction is provided. The computing apparatus in some embodiments includes at least one processor and at least one non-transitory memory, the at least non-transitory one memory having computer-coded instructions stored thereon. The computer-coded instructions in execution with the at least one processor causes the apparatus to perform any one of the example computer-implemented methods described herein. In some other embodiments, the computing apparatus includes means for performing each step of any of the computer-implemented methods described herein.

In accordance with another aspect of the present disclosure, a computer program product for improved landing distance prediction is provided. The computer program product in some embodiments includes at least one non-transitory computer-readable storage medium having computer program code stored thereon. The computer program code in execution with at least one processor is configured for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a networked environment that may be specially configured within which embodiments of the present disclosure may operate.

FIG. 2 illustrates a block diagram of an example apparatus that may be specially configured in accordance with at least some example embodiments of the present disclosure.

FIG. 3 illustrates an example data architecture in accordance with at least some example embodiments of the present disclosure.

FIG. 4 illustrates a flowchart depicting operations of an example process for predicting a landing distance in accordance with at least some example embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Embodiments of the present disclosure provide a myriad of technical advantages in the technical field of predicting landing distances for vehicles. Typically, a vehicle landing distance is predicted by a vehicle operator or vehicle traffic controller based solely upon vehicle data. For example, in an aerial context, the length of runway required to safely land an aerial vehicle may be generated based on vehicle elevation, descent rate, airspeed, and/or the like. In such approaches, a landing distance prediction may be inaccurate due to failure to consider additional factors, such as conditions of the runway. For example, a vehicle may require greater landing distance on a wet runway or ice-covered runway as compared to a dry runway. In instances where such conditions are taken into account for landing distance prediction, the models used to generate landing distance prediction may still generate predictions that differ from true landing distances for the runway.

Embodiments of the present disclosure overcome the technical challenges of generating accurate landing predictions by generating and providing a compensation factor indicative of differences in historical predicted and true landing distances generated by such models. The various embodiments of the present disclosure may provide the historical predicted and true landing distances for a runway to an approaching vehicle to enable the approaching vehicle to generate a compensation factor that may be used by the vehicle to account for the historical deltas and, thereby, generate a more accurate landing distance.

For example, when predicting aircraft landing distance on a runway, one of the predicted factors is based on the aircraft performance data, which contains fixed predicted landing distance for different runway conditions (e.g., different thicknesses of snow, ice, etc.). However, runway condition may be more complicated than those pre-defined conditions such that predicted landing distances deviate significantly from true landing distances due to runway factors not captured in the model. When runway conditions deviate from the fixed set of performance numbers represented in the model, the predicted landing distance may demonstrate inaccuracy, potentially resulting in a hard or unsafe landing that may damage the aircraft, its cargo, and/or passengers. In various embodiments, the present method, apparatus, and computer program product provide historical predicted landing distances and true landing distances to a vehicle on approach such that the variation in predicted performance vs. true performance may be compensated for in computation of the landing distance at the vehicle. In doing so, the method, apparatus, and computer program product may enable generated of a weighted landing distance that is more accurate as compared to outputs of previous landing distance techniques.

### Definitions

“Vehicle” refers to any apparatus that traverses throughout an environment by any mean of travel. In some contexts, a vehicle transports goods, persons, and/or the like, or traverses itself throughout an environment for any other purpose, by means of air, sea, or land. In some embodiments, a vehicle is ground-based, air-based, water-based, space-based (e.g., outer space or within an orbit of a planetary body, a natural satellite, or artificial satellite), and/or the like. In some embodiments, the vehicle is an aerial vehicle capable of air travel. Non-limiting examples of aerial vehicles include urban air mobility vehicles, drones, helicopters, fully autonomous air vehicles, semi-autonomous air vehicles, airplanes, orbital craft, spacecraft, rotorcraft, and/or the like. In some embodiments, the vehicle is piloted by a human operator onboard the vehicle. For example, in an aerial context, the vehicle may be a commercial airliner operated by a flight crew. In some embodiments, the vehicle is remotely controllable such that a remote operator may initiate and direct movement of the vehicle. Additionally, in some embodiments, the vehicle is unmanned. For example, the vehicle may be a powered, aerial vehicle that does not carry a human operator and is piloted by a remote operator using a control station. In some embodiments, the vehicle is an aquatic vehicle capable of surface or subsurface travel through and/or atop a liquid medium (e.g., water, water-ammonia solution, other water mixtures, and/or the like). Non-limiting examples of aquatic vehicles include unmanned underwater vehicles (UUVs), surface watercraft (e.g., boats, jet skis, and/or the like), amphibious watercraft, hovercraft, hydrofoil craft, and/or the like. As used herein, vehicle may refer to vehicles associated with urban air mobility (UAM).

“UAM” refers to urban air mobility, which includes all aerial vehicles and functions for aerial vehicles that are capable of performing vertical takeoff and/or vertical landing procedures. Non-limiting examples of UAM aerial vehicles include passenger transport vehicles, cargo transport vehicles, small package delivery vehicles, unmanned aerial system services, autonomous drone vehicles, and ground-piloted drone vehicles, where any such vehicle is capable of performing vertical takeoff and/or vertical landing. In various embodiments, the method, apparatus, and computer program product described herein are configured to generate predicted landing distances, compensation factors, weighted landing distances, and/or the like for UAM vehicles. In at least a subset of such embodiments, the method, apparatus, and computer program product generate predicted landing distances, compensation factors, weighted landing distances, and/or the like using a model associated with landing site conditions, such as wind, temperature, humidity, air pressure, vehicle traffic density, and/or the like.

“Landing distance” refers to any length of surface used by a vehicle to come to a complete stop or predetermined velocity. For example, in an aerial context, a landing distance may be a length of runway used by an aerial vehicle to touchdown, decelerate, and reach a complete stop or predetermined taxiing speed. As another example, a landing distance may be a length of runway used by a ground-based vehicle to decelerate to a complete stop. In still another example, a landing distance may be a length of a waterway used by an aquatic vehicle to decelerate to a complete stop or idling speed. In some embodiments, landing distance includes a vertical delta and/or horizontal delta of a vehicle respective to a target landing site. For example, in a UAM context, landing distance may include a vertical distance between a vehicle and a landing site.

“Predicted landing distance” refers to any estimate of surface length that may be required by a vehicle to reach a complete stop or predetermined velocity. For example, in an aerial context, a predicted landing distance may be an estimate of runway length that will be required for an aerial vehicle to reach a complete stop or decelerate to a predetermined taxiing speed following touchdown of the vehicle upon the runway.

“True landing distance” refers to an actual surface length required by a vehicle to reach a complete stop or predetermined velocity. For example, in an aerial context, true landing distance may be a distance travel upon a runway from a point of vehicle touchdown to a point at which the vehicle comes to a complete stop or decelerates to a predetermined taxiing speed.

### Example Systems and Apparatuses of the Disclosure

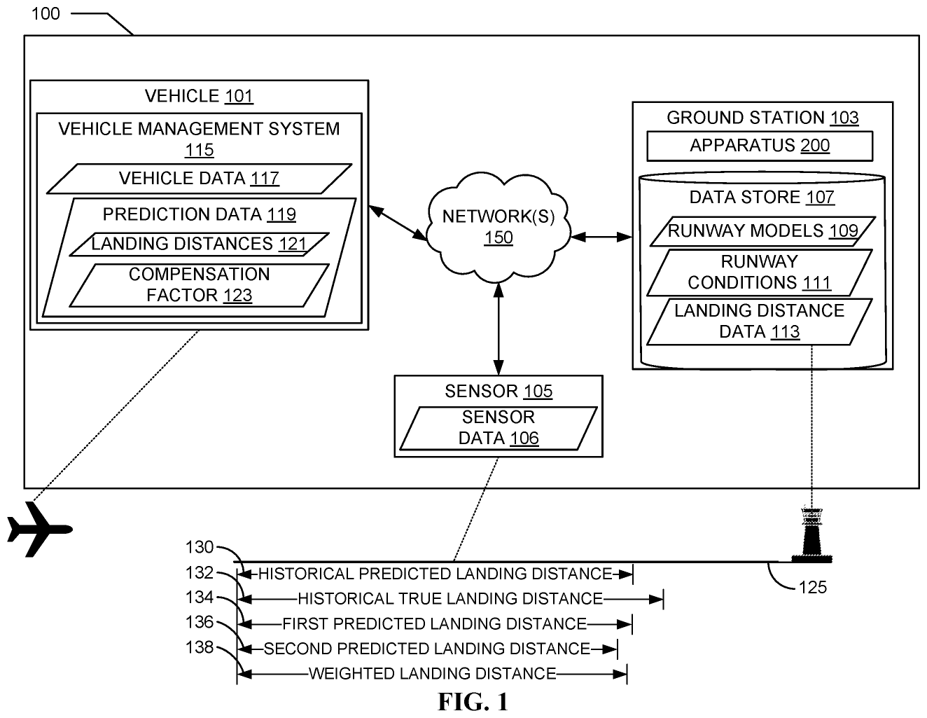

FIG. 1 illustrates a block diagram of a networked environment that may be specially configured within which embodiments of the present disclosure may operate. Specifically, FIG. 1 depicts an example networked environment 100. As illustrated, the networked environment 100 includes one or more vehicles 101, a ground station 103, and one or more sensors 105.

In some embodiments, the ground station 103 includes an apparatus 200 configured to perform various functions and actions related to enacting techniques and processes described herein for predicting landing distances, generating runway conditions, providing predictions and instructions to a vehicle 101 and/or the like. In some embodiments, the ground station 103 is configured to provide data to and receive data from one or more vehicles 101, one or more sensors 105, and/or the like. In some embodiments, the ground station 103 includes one or more data stores 107. The various data in the data store 107 may be accessible to one or more of the apparatus 200, the vehicle 101, and/or the like. The data store 107 may be representative of a plurality of data stores 107 as can be appreciated. The data stored in the data store 107, for example, is associated with the operation of the various applications, apparatuses, and/or functional entities described herein. The data stored in the data store 107 may include, for example, runway models 109, runway conditions 111, landing distance data 113, and/or the like.

In some embodiments, the apparatus 200 is configured to receive sensor data 106 from one or more sensors 105. The sensor 105 may be configured to generate one or more readings associated with a runway 125, an environment adjacent to the runway 125, and/or the like. For example, the sensor 105 may generate sensor data 106 indicative of runway moisture, precipitation, wind, visibility, and/or the like. In some embodiments, the sensor 105 includes anemometers, radar sensors, barometers, thermometers, optical sensors, precipitation sensors, and/or the like.

In some embodiments, the apparatus 200 is configured to generate one or more runway conditions 111 based at least in part on the sensor data 106. For example, the apparatus may generate precipitation thicknesses, wind directions and velocities, and/or the like, which may impact landing distances for vehicles 101 attempting to land upon the runway 125. In some embodiments, the apparatus 200 is configured to retrieve a runway model 109 for use in landing distance prediction based at least in part on the one or more runway conditions 111. For example, the apparatus 200 may retrieve a runway model 109 that is associated with a predetermined range of snow compaction, ice thickness, frost, and/or the like.

In some embodiments, the apparatus 200 is configured to receive vehicle data 117 from the vehicle 101. In some embodiments, the apparatus 200 is configured to generate landing distance data 113 using the runway model 109 and based at least in part on the vehicle data 117. For example, the apparatus 200 may generate predicted landing distances 134. In some embodiments, the apparatus 200 obtains true landing distances associated with vehicle landings. In some embodiments, the apparatus 200 stores true landing distances and associated landing distance predictions as historical true landing distances 132 and historical predicted landing distances 130, respectively. In doing so, the apparatus 200 may enable subsequent retrieval and provision of the historical true and predicted landing distances 132, 130 to a vehicle management system 115 to enable the vehicle management system 115 to generate compensation factors 123.

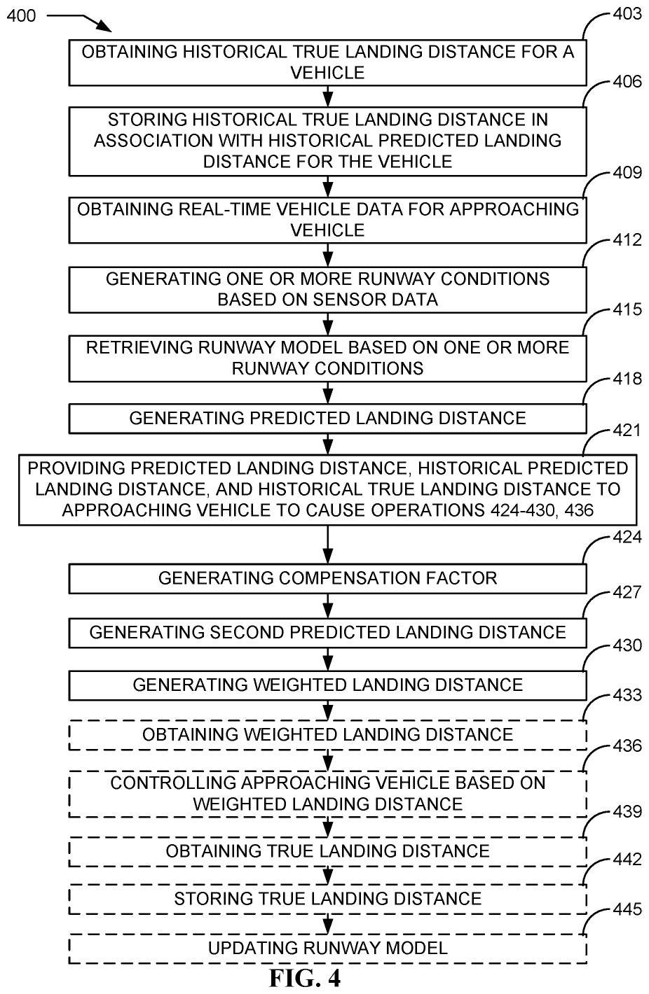

In some embodiments, the apparatus 200 is configured to generate a first predicted landing distance 134 for an approaching vehicle 101 based at least in part on real-time vehicle data 117 for the vehicle and a runway model 109 retrieved based on current runway conditions 111 on a target runway 125. In some embodiments, the apparatus 200 retrieves historical predicted landing distances 130 and historical true landing distances 132 associated with the runway. In some embodiments, the apparatus 200 is configured to provide the first predicted landing distance 134, the historical predicted landing distances 130, and the historical true landing distances 132 to the vehicle 101. In doing so, the apparatus 200 may cause the vehicle management system 115 to generate a compensation factor 123 based at least in part on the historical predicted landing distances 130 and the historical true landing distances 132 and generate a weighted landing distance 138 based at least in part on the first predicted landing distance 134, a second predicted landing distance 136 generated by the vehicle management system, and the compensation factor. The historical predicted landing distances 130 may differ from the historical true landing distances 132, and the compensation factor 123 may represent an average magnitude of the difference. The vehicle management system 115 may use the compensation factor 123 to generate a weighted landing distance, which may be more accurate to a true landing distance of the vehicle on the runway. Thus, the weighted landing distance may enable safer, more accurate landing of the vehicle upon the runway 125. Additional aspects of landing distance prediction are shown in the landing distance prediction process shown in FIG. 4 and described herein.

In some embodiments, the vehicle 101 includes a vehicle management system 115 configured to control operation of the vehicle 101. For example, the vehicle management system 115 may include one or more vehicle controls (e.g., thrust, brakes, flaps, and/or the like). In some embodiments, the vehicle management 115 includes an autopilot and/or the like that automatically controls the vehicle 101. In some embodiments, the vehicle management system 115 includes one or more vehicle recording systems configured to obtain and report one or more aspects of the vehicle or operation thereof. For example, the vehicle management system 115 may include a transponder, data uplink system, traffic collision avoidance system (TCAS), automatic dependent surveillance-broadcast (ADS-B), flight recorder, and/or the like.

In some embodiments, the vehicle management system 115 is configured to receive runway conditions 111, landing distance data 113, and/or the like from the ground station 103. In some embodiments, the vehicle management system 115 is configured to generate and store vehicle data 117, prediction data 119, and/or the like. In some embodiments, the vehicle management system 115 includes any number of computing device(s) and/or other system(s) embodied in hardware, software, firmware, and/or the like that generate vehicle data 117, prediction data 119, and/or the like. For example, the vehicle management system 115 may generate real-time vehicle data 117 based at least in part on measurements obtained from one or more vehicle recording systems. In another example, the vehicle management system 115 may generate a predicted landing distance 136 based at least in part on the real-time vehicle data 117. The vehicle management system 115 may generate a compensation factor 123 based at least in part on historical predicted landing distances 130 and historical true landing distances 132. For example, the vehicle management system 115 may include any number of computing device(s) and/or other system(s) embodied in hardware, software, firmware, and/or the like that generate an average delta or offset based at least in part on differences between historical predicted landing distances and historical true landing distances.

In some embodiments, the vehicle management system 115 is configured to generate the weighted landing distance 138 based at least in part on a compensation factor 123, a predicted landing distance 134 from the ground station 103, and the predicted landing distance 136. In some embodiments, the vehicle management system 115 applies the compensation factor 123 to the predicted landing distance 134 to configure a level of contribution of the predicted landing distance 134 to computation of the weighted landing distance 138. In some embodiments, vehicle management system 115 is configured to control the vehicle 101 based at least in part on the weighted landing distance 138. For example, the vehicle management system 115 may control the landing of the vehicle 101 upon a runway by configuring one or more landing parameters based at least in part on the weighted landing distance 138. The landing parameters may include descent rate, thrust, speed, nose angle, braking, flap orientation, and/or the like. In some embodiments, the vehicle management system 115 includes one or more displays on which vehicle data 117, prediction data 119, runway conditions 111, landing distance data 113, sensor data 106, and/or the like may be rendered.

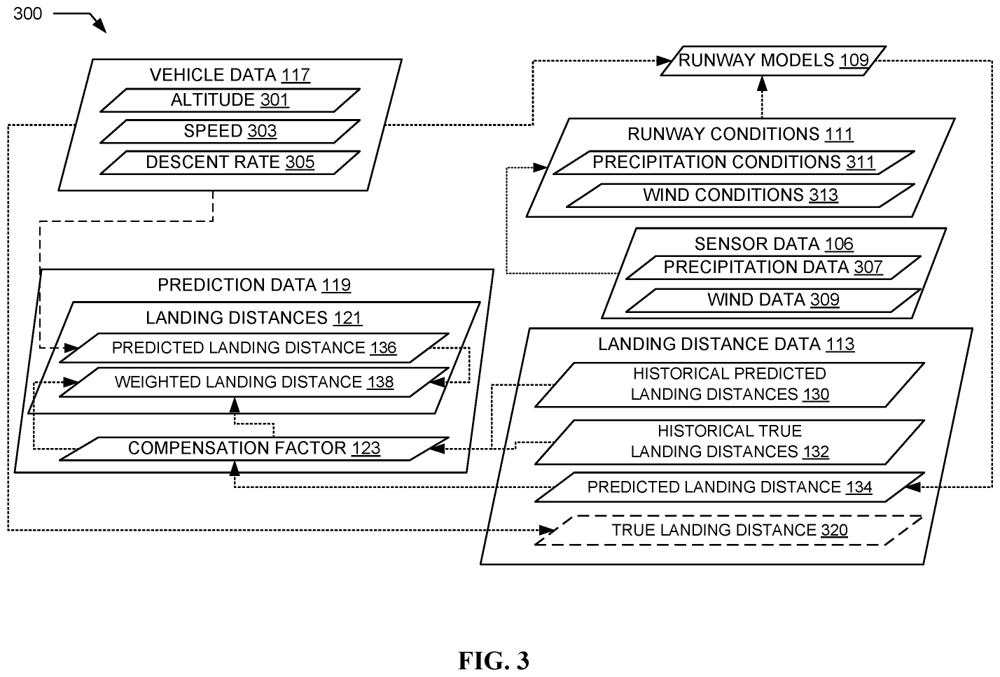

Additional example aspects of the sensor data 106, runway model 109, runway conditions 111, landing distance data 113, vehicle data 117, prediction data 119 are shown in the data architecture 300 depicted in FIG. 3 and described herein.

In some embodiments, the ground station 103, vehicle 101, and sensor 105 are communicable over one or more communications network(s), for example the communications network(s) 150. It should be appreciated that the communications network 150 in some embodiments is embodied in any of a myriad of network configurations. In some embodiments, the communications network 150 embodies a public network (e.g., the Internet). In some embodiments, the communications network 150 embodies a private network (e.g., an internal, localized, and/or closed-off network between particular devices). In some other embodiments, the communications network 150 embodies a hybrid network (e.g., a network enabling internal communications between particular connected devices and external communications with other devices). In some embodiments, the communications network 150 embodies a satellite-based communication network. Additionally, or alternatively, in some embodiments, the communications network 150 embodies a radio-based communication network that enables communication between the apparatus 200 and the vehicle 101. For example, the apparatus 200 may provision landing distance data 113 to and receive prediction data 119 from a vehicle management system 115 via a transponder, communication gateway, and/or the like. The communications network 150 in some embodiments may include one or more transponders, satellites, base station(s), relay(s), router(s), switch(es), cell tower(s), communications cable(s) and/or associated routing station(s), and/or the like. In some embodiments, the communications network 150 includes one or more user-controlled computing device(s) (e.g., a user owner router and/or modem) and/or one or more external utility devices (e.g., Internet service provider communication tower(s) and/or other device(s)).

Each of the components of the system communicatively coupled to transmit data to and/or receive data from one another over the same or different wireless or wired networks embodying the communications network 150. Such configuration(s) include, without limitation, a wired or wireless Personal Area Network (PAN), Local Area Network (LAN), Metropolitan Area Network (MAN), Wide Area Network (WAN), satellite network, radio network, and/or the like. Additionally, while FIG. 1 illustrate certain system entities as separate, standalone entities communicating over the communications network 150, the various embodiments are not limited to this particular architecture. In other embodiments, one or more computing entities share one or more components, hardware, and/or the like, or otherwise are embodied by a single computing device such that connection(s) between the computing entities are over the communications network 150 are altered and/or rendered unnecessary.

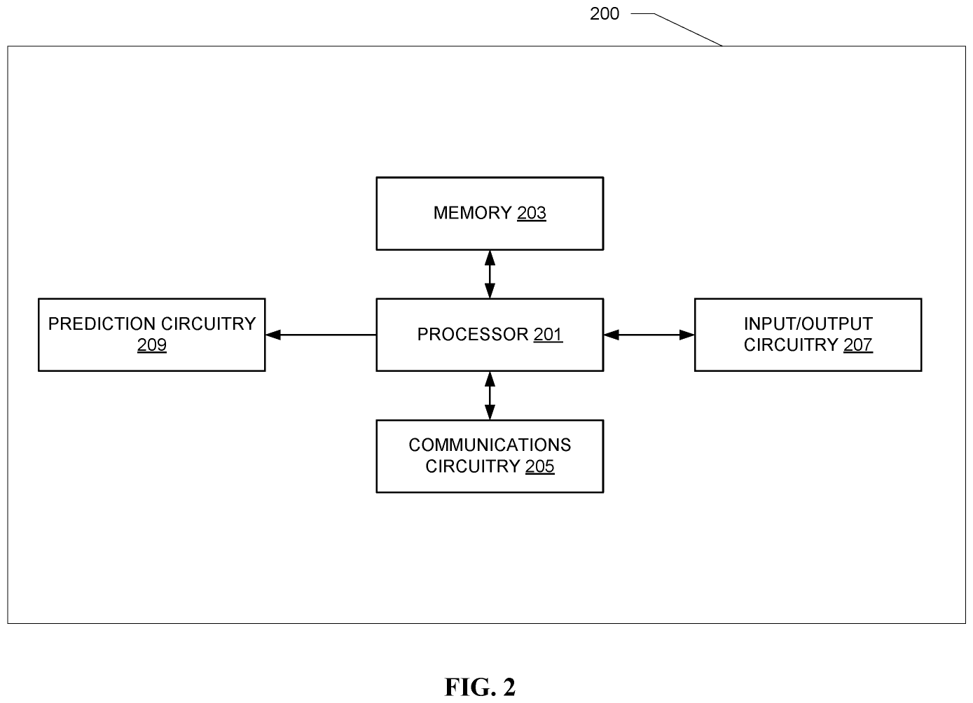

FIG. 2 illustrates a block diagram of an example apparatus 200 that may be specially configured in accordance with at least some example embodiments of the present disclosure. The apparatus 200 may carry out functionality and processes described herein to generate runway conditions, obtain true landing distances, generate predicted landing distances, cause performance of functions at a vehicle, and/or the like. In some embodiments, the apparatus 200 includes a processor 201, memory 203, communications circuitry 205, input/output circuitry 207, and prediction circuitry 209. In some embodiments, the apparatus 200 is configured, using one or more of the processor 201, memory 203, communications circuitry 205, input/output circuitry 207, and/or prediction circuitry 209, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, controlling, modifying, restoring, processing, displaying, storing, determining, creating/generating, predicting, monitoring, evaluating, comparing, and/or similar terms used herein interchangeably. In one embodiment, these functions, operations, and/or processes may be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Additionally, or alternatively, in some embodiments, other elements of the apparatus 200 provide or supplement the functionality of another particular set of circuitry. For example, the processor 201 in some embodiments provides processing functionality to any of the sets of circuitry, the memory 203 provides storage functionality to any of the sets of circuitry, the communications circuitry 205 provides network interface functionality to any of the sets of circuitry, and/or the like.

In some embodiments, the processor 201 (and/or co-processor or any other processing circuitry assisting or otherwise associated with the processor) is/are in communication with the memory 203 via a bus for passing information among components of the apparatus 200. In some embodiments, for example, the memory 203 is non-transitory and may include, for example, one or more volatile and/or non-volatile memories. In other words, for example, the memory 203 in some embodiments includes or embodies an electronic storage device (e.g., a computer readable storage medium). In some embodiments, the memory 203 is configured to store information, data, content, applications, instructions, or the like, for enabling the apparatus 200 to carry out various functions in accordance with example embodiments of the present disclosure (e.g., generating runway conditions, generating landing distance predictions, obtaining real-time vehicle data, obtaining sensor data, causing performance of functions at a vehicle and/or the like). In some embodiments, the memory 203 is embodied as a data store 107 as shown in FIG. 1 and described herein. In some embodiments, the memory 203 includes runway models 109, runway conditions 111, landing distance data 113, and/or the like, as further architected in FIG. 3 and described herein.

The processor 201 may be embodied in a number of different ways. For example, in some embodiments, the processor 201 includes one or more processing devices configured to perform independently. Additionally, or alternatively, in some embodiments, the processor 201 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 201 is configured to execute instructions stored in the memory 203 or otherwise accessible to the processor. Additionally, or alternatively, the processor 201 in some embodiments is configured to execute hard-coded functionality. As such, whether configured by hardware or software methods, or by a combination thereof, the processor 201 represents an entity (e.g., physically embodied in circuitry) capable of performing operations according to an embodiment of the present disclosure while configured accordingly. Additionally, or alternatively, as another example in some example embodiments, when the processor 201 is embodied as an executor of software instructions, the instructions specifically configure the processor 201 to perform the algorithms embodied in the specific operations described herein when such instructions are executed.

As one particular example embodiment, the processor 201 is configured to perform various operations associated with predicting a landing distance for a vehicle and causing the vehicle to generate compensation factors and weighted prediction distances. In some embodiments, the processor 201 includes hardware, software, firmware, and/or the like, that store real-time vehicle data in memory, retrieve runway models, generate runway conditions, update runway models, generate instructions for controlling a vehicle, and/or the like. For example, the processor 201 may generate one or more runway conditions 111 based at least in part on sensor data 106. As another example, the processor 201 may determine whether a weighted landing distance meets a predetermined threshold for safely landing upon a runway. As another example, the processor 201 may generate an instruction for a vehicle to land upon a particular runway, avoid landing a runway, enter a holding pattern, and/or the like.

In some embodiments, the apparatus 200 includes input/output circuitry 207 that provides output to a user (e.g., an operating entity of a vehicle 101 or ground station 103) and, in some embodiments, receives an indication of a user input. For example, in some contexts, the input/output circuitry 207 provides output to and receives input from one or more ground station operators, vehicles, sensors, and/or the like. In some embodiments, the input/output circuitry 207 is in communication with the processor 201 to provide such functionality. The input/output circuitry 207 may comprise one or more user interface(s) and in some embodiments includes a display that comprises the interface(s) rendered as a web user interface, an application user interface, a user device, a backend system, or the like. In some embodiments, the input/output circuitry 207 also includes a keyboard, a mouse, a joystick, a touch screen, touch areas, soft keys a microphone, a speaker, and/or other input/output mechanisms. The processor 201 and/or input/output circuitry 207 comprising the processor may be configured to control one or more functions of one or more user interface elements through computer program instructions (e.g., software and/or firmware) stored on a memory accessible to the processor 201 (e.g., memory 203, and/or the like). In some embodiments, the input/output circuitry 207 includes or utilizes a user-facing application to provide input/output functionality to a display of a ground station 103, vehicle 101 and/or other display associated with a user.

In some embodiments, the apparatus 200 includes communications circuitry 205. The communications circuitry 205 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 205 includes, for example, a network interface for enabling communications with a wired or wireless communications network, such as the network 150 shown in FIG. 1 and described herein. Additionally, or alternatively in some embodiments, the communications circuitry 205 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 205 includes circuitry for interacting with the antenna(s) and/or other hardware or software to cause transmission of signals via the antenna(s) or to handle receipt of signals received via the antenna(s). In some embodiments, the communications circuitry 205 enables transmission to and/or receipt of data from a vehicle management system 115 and/or other external computing devices in communication with the apparatus 200.

The prediction circuitry 209 includes hardware, software, firmware, and/or a combination thereof, that predict landing distances. For example, in some contexts, the prediction circuitry 209 includes hardware, software, firmware, and/or the like, that process real-time vehicle data using a runway model to generate a predicted landing distance for a vehicle eon approach to a runway. In some embodiments, the prediction circuitry 209 includes hardware, software, firmware, and/or the like, that determine one of a plurality of runway models to utilize for landing distance prediction based at least in part on one or more runway conditions. In some embodiments, the prediction circuitry 209 includes hardware, software, firmware, and/or the like, that update a runway model based on a true landing distance, compensation factor, and/or the like. In some embodiments, the prediction circuitry 209 includes a separate processor, specially configured field programmable gate array (FPGA), and/or a specially programmed application specific integrated circuit (ASIC).

Additionally, or alternatively, in some embodiments, two or more of the processor 201, memory 203, communications circuitry 205, input/output circuitry 207, and/or prediction circuitry 209 are combinable. Additionally, or alternatively, in some embodiments, one or more of the sets of circuitry perform some or all of the functionality described associated with another component. For example, in some embodiments, two or more of the sets of circuitry 201-209 are combined into a single module embodied in hardware, software, firmware, and/or a combination thereof. Similarly, in some embodiments, one or more of the sets of circuitry, for example the memory 203, communication interface 205, and/or prediction circuitry 209 is/are combined with the processor 201, such that the processor 201 performs one or more of the operations described above with respect to each of these sets of circuitry 203-209.

### Example Data Architecture of the Disclosure

Having described example systems and apparatuses in accordance with embodiments of the present disclosure, example architectures of data in accordance with the present disclosure will now be discussed. In some embodiments, the systems and/or apparatuses described herein maintain data environment(s) that enable the workflows in accordance with the data architectures described herein. For example, in some embodiments, the systems and/or apparatuses described herein function in accordance with the data architectures depicted and described herein with respect to FIG. 3 are maintained via the apparatus 200.

FIG. 3. illustrates an example data architecture 300 in accordance with at least some example embodiments of the present disclosure. In some embodiments, the vehicle data 117 includes altitude 301, speed 303, descent rate 305, and/or the like. In some embodiments, the speed 303 includes airspeed, vertical speed, groundspeed, and/or the like. Additionally, in some embodiments, the vehicle data 117 includes heading, pitch, roll, yaw, and/or the like. In some embodiments, the vehicle data 117 includes a current location of the vehicle, engine performance (e.g., thrust settings, fuel flow, temperatures, pressures, and/or the like), vehicle control inputs, and/or the like. In some embodiments, the vehicle data 117 include statuses of hydraulic systems, electrical systems, plumbing systems, vehicle control systems, and/or the like, that are onboard the vehicle 101.

In some embodiments, the sensor data 106 includes precipitation data 307, wind data 309, and/or the like. In some embodiments, precipitation data 307 includes measurements of precipitation density, volume, or other dimensions. For example, precipitation data 307 may include a depth of snow, ice, slush, sleet, and/or the like, present on a runway. In another example, precipitation data 307 may include measurements of snow texture, ice particle size, precipitation rate, precipitation duration, and/or the like. In some embodiments, precipitation data 307 includes one or more measurements indicative of runway visual range (RVR) based on fog or other forms of precipitation. In sone embodiments, wind data 309 includes measurements of wind velocity, direction, frequency, duration, and/or the like. In some embodiments, wind data 309 includes measurements of wind velocity and direction at one or more elevations at or above a runway, one or more distances proximate to the runway, one or more time intervals, and/or the like. In some embodiments, sensor data 106 includes measurements of humidity, pressure, temperature, runway moisture, and/or the like.

In some embodiments, one or more runway conditions 111 are generated based at least in part on sensor data 106. In some embodiments, the runway conditions 111 include precipitation conditions 311, wind conditions 313, and/or the like. In some embodiments, precipitation conditions 311 include snow thickness, snow compactness, ice thickness, slush thickness, slipperiness (e.g., runway moving coefficient of friction, and/or the like), frost coverage, water depth, and/or the like. In some embodiments, wind conditions 313 include headwind, crosswind, tailwind, or gust magnitude, direction, and/or frequency. In some embodiments, a runway condition 111 includes runway visible range (RVR). In some embodiments, a runway condition 111 includes runway elevation. In some embodiments, a runway condition 111 includes humidity.

In some embodiments, a runway model 109 includes any algorithmic, statistical, and/or machine learning model that generates a landing distance prediction based at least in part on one or more inputs. In some embodiments, a runway model 109 is associated with a particular runway, runway condition, vehicle classification, and/or the like. For example, in an aerial context, an airport may include a first runway model 109 associated with a first runway and a second runway model 109 associated with a second runway model. In another example, a runway model 109 may be associated with runways demonstrating a particular precipitation condition 311, such as a predetermined range of snow thickness, snow compactness, ice thickness, RVR, and/or the like. In another example, a runway model 109 may be associated with a particular vehicle make, vehicle model, vehicle weight, and/or the like. A runway model 109 may be associated with a combination of runway conditions, vehicle classifications, and/or the like, as can be appreciated.

In some embodiments, a runway model 109 is configured to generate a predicted landing distance 134 based at least in part on vehicle data 117, one or more runway conditions 111, one or more vehicle classifications, and/or the like. In some embodiments, based at least in part one or more runway conditions 111 and/or vehicle classifications, a particular runway model 109 of a plurality of stored runway models may be used to generate the predicted landing distance. In some embodiments, a runway model 109 may be updated by the apparatus 200 based at least in part on true landing distances 320. For example, subsequent to a runway model 109 generating a landing prediction for an approaching vehicle, the runway model 109 may be updated based at least in part on a true landing distance for the vehicle to enable improvement of model accuracy in future landing distance predictions.

In some embodiments, landing distance data 113 includes one or more historical predicted landing distances 130 and one or more historical true landing distances 132, where a respective pair of historical predicted and true landing distances may be associated with a vehicle that previously landed upon a runway. In some embodiments, the historical predicted landing distance 130 and historical true landing distance 132 are associated with a runway identifier, vehicle classification, environmental condition, runway model identifier, and/or the like, such that relevant historical data may be subsequently retrieved and provided to a vehicle approaching the same runway under similar or the same conditions (e.g., and where, in some embodiments the approaching vehicle may share one or more of the same classifications). In some embodiments, the landing distance data 113 includes a predicted landing distance 134 that is associated with a vehicle approaching a runway. In some embodiments, the landing distance data 113 includes a plurality of predicted landing distances associated with the approaching vehicle respective to different time intervals and, thereby, different vehicle data. For example, the landing distance data 113 may include a plurality of predicted landing distances associated with multiple stages of approach to a runway. In some embodiments, the landing distance data 113 includes a true landing distance 320 for the approaching vehicle, which may be received from the vehicle or generated by the ground station 103. Additionally, in some embodiments, the landing distance data includes predicted landing distances, compensation factors, weighted landing distances, and/or the like generated by the approaching vehicle.

In some embodiments, the prediction data 119 includes landing distances 121 and one or more compensation factors 123. In some embodiments, the landing distances 121 include predicted landing distances 134 received by an approaching vehicle from a ground station. In some embodiments, the landing distances 121 include predicting landing distances 136 generated by the vehicle management system based at least in part on real-time vehicle data 117. In some embodiments, the compensation factor 123 is generated based at least in part on one or more pairs of historical predicted landing distances 130 and historical true landing distances 132. For example, a respective delta between pairs of historical predicted landing distance and historical true landing distance may be generated, and an average offset of the true landing distance to the historical predicted landing distance may be generated based on the delta values. In some embodiments, a weighted landing distance 138 is generated based on the compensation factor, the predicted landing distance 136 generated by the vehicle, and the predicted landing distance 134 generated by the landing distance data 113. The compensation factor 123 may be applied to the predicted landing distance 134 to control the contribution of the predicted landing distance 134 to the computation of the weighted landing distance 138. For example, in an instance where predicted landing distances of the ground station demonstrate a large delta from corresponding true landing distances, the compensation factor may cause a reduction in the contribution of the predicted landing distance 134 to the weighted landing distance computation. In an instance where predicted landing distances of the ground station demonstrate a small delta versus true landing distances, the predicted landing distance 134 may provide a greater contribution to the weighted landing distance as compared to the predicted landing distance 136.

### Example Processes of the Disclosure

Having described example systems and apparatuses, data architectures, and data flows in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

FIG. 4 illustrates a flowchart depicting operations of an example process 400 for predicting a landing distance of a vehicle approaching a runway in accordance with at least some example embodiments of the present disclosure. In some embodiments, the process 400 is embodied by computer program code stored on a non-transitory computer-readable storage medium of a computer program product configured for execution to perform the process as depicted and described. Additionally, or alternatively, in some embodiments, the process 400 is performed by one or more specially configured computing devices, such as apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 203 and/or another component depicted and/or described herein and/or otherwise accessible to the apparatus 200, for performing the operations as depicted and described.

In some embodiments, the apparatus 200 is in communication with one or more internal or external apparatus(es), system(s), device(s), and/or the like, to perform one or more of the operations as depicted and described. For example, the apparatus 200 may communicate with one or more sensors 105, one or more vehicle management systems 115, and/or the like to perform one or more operations of the process 400.

At operation 403, the apparatus 200 includes means such as the prediction circuitry 209, the communications circuitry 205, the input/output circuitry 207, the processor 201, and/or the like, or a combination thereof, that obtain a respective historical true landing distance for one or more vehicles. For example, the apparatus 200 may receive from a vehicle 101 a true landing distance for the vehicle upon a particular runway. As another example, the apparatus 200 may generate a true landing distance of the vehicle 101 based at least in part on sensor data from one or more sensors, radar arrays, and/or the like. In various embodiments, the historical true landing distance obtained at operation 403 is associated with a vehicle for which the apparatus 200 previously generated a predicted landing distance. For example, prior to obtaining the true landing distance, the apparatus 200 may obtain real-time vehicle data for the vehicle on approach to the runway and generate a predicted landing distance of the vehicle upon the runway.

At operation 406, the apparatus 200 includes means such as the prediction circuitry 209, the communications circuitry 205, the input/output circuitry 207, the processor 201, and/or the like, or a combination thereof, that store the historical true landing distance in association with a historical predicted landing distance for the vehicle. For example, the apparatus 200 may store the historical true landing distance of operation 403 in association with a historical predicted landing distance previously generated for the same vehicle 101 prior to landing upon the runway. In some embodiments, the apparatus 200 stores the historical true and predicted landing distances in association with one or more classifications of the vehicle, one or more runway conditions, one or more runway models, and/or the like. For example, the apparatus 200 may store the historical true and predicted landing distances in association with a vehicle make, vehicle model, vehicle weight, vehicle speed, vehicle descent rate, landing timestamp, precipitation condition, wind condition, runway elevation, runway visual range (RVR), and/or the like.

At operation 409, the apparatus 200 includes means such as the prediction circuitry 209, the communications circuitry 205, the input/output circuitry 207, the processor 201, and/or the like, or a combination thereof, that obtain real-time vehicle data for a vehicle approaching the runway. For example, the apparatus 200 may receive from an approaching vehicle 101 real-time vehicle data including vehicle airspeed, descent rate, altitude, bearing, thrust, flap orientation, weight, and/or the like. As another example, the apparatus 200 may receive real-time vehicle data from one or more ground-based vehicle monitoring systems, such as radar arrays, vehicle traffic systems, automatic dependent surveillance-broadcast (ADS-B) receivers, skywatchers, and/or the like. In some embodiments, the real-time vehicle data includes one or more vehicle classifications and/or vehicle information based upon which the apparatus 200 may associate the approaching vehicle with one or more vehicle classifications. For example, the real-time vehicle data may include a make, model, weight, cargo, and/or the like of the vehicle. In another example, the real-time vehicle data may include an identifier of the vehicle based upon which the apparatus 200 may associate the vehicle with one or more vehicle classifications, such as make, model, weight, braking capability, landing speeds, and/or the like.

At operation 412, the apparatus 200 includes means such as the prediction circuitry 209, the communications circuitry 205, the input/output circuitry 207, the processor 201, and/or the like, or a combination thereof, that generate one or more runway conditions for the runway based at least in part on sensor data from one or more sensors. For example, the apparatus 200 may receive sensor data from one or more sensors 105 configured to measure one or more phenomena related to the runway. In some embodiments, the sensor data includes readings related to precipitation. For example, the sensor data may include ice level, snow level, snow density, moisture content, sleet level, slush level, and/or the like. As another example, the sensor data may include wind velocity, wind direction, gust velocity, gust direction, gust frequency, and/or the like, any of which may be further based upon one or more elevations relative to the runway. In another example, the sensor data may include measurements of fog, dust, smoke, or other visibility-impacting phenomena present on the runway. In still another example, the sensor data may include runway elevation, runway length, foreign object debris volume, and/or the like.

In some embodiments, the apparatus 200 generates one or more precipitation conditions, one or more wind conditions, and/or the like. For example, the apparatus 200 may generate an ice thickness, snow thickness, slush thickness, frost thickness, snow compaction, and/or the like based at least in part on the sensor data. In another example, the apparatus 200 generates one or more wind conditions based at least in part on the sensor data, such as headwind, crosswind, tailwind, or gust magnitude, direction, and/or frequency. In some embodiments, the apparatus 200 generates a runway visual range (RVR) based at least in part on the sensor data. In some embodiments, the apparatus 200 generates a runway length, runway elevation, and/or the like based at least in part on the sensor data. Additionally, or alternatively, in some embodiments, the apparatus 200 retrieves one or more historical runway conditions from a data store 107. For example, the apparatus 200 may retrieve a runway elevation, runway length, and/or the like from the data store 107.

At operation 415, the apparatus 200 includes means such as the prediction circuitry 209, the communications circuitry 205, the input/output circuitry 207, the processor 201, and/or the like, or a combination thereof, that retrieve a stored runway model based at least in part on the one or more runway conditions. For example, the apparatus 200 may retrieve one of a plurality of runway models based at least in part on the runway conditions generated at operation 412. For example, in response to generating a runway condition of ice thickness within a predetermined range, the apparatus 200 may retrieve a runway model 109 associated with modeling landing distances along a runway comprising ice thickness within the predetermined range. As another example, in response to generating a runway condition of headwind within a predetermined velocity range, the apparatus 200 may retrieve a runway model 109 associated with the headwind condition and velocity range. In some embodiments, the apparatus 200 retrieves the runway model based at least in part on one or more classifications of the approaching vehicle. For example, the apparatus 200 may retrieve a particular runway model 109 of a plurality of stored runway models 109 based at least in part on a make, model, weight, cargo, and/or the like that is associated with the approaching vehicle.

At operation 418, the apparatus 200 includes means such as the prediction circuitry 209, the communications circuitry 205, the input/output circuitry 207, the processor 201, and/or the like, or a combination thereof, that generate a predicted landing distance for the approaching vehicle upon the runway. For example, the apparatus 200 may generate a predicted landing distance for the approaching vehicle using the retrieved runway model and based at least in part on the real-time vehicle data associated with the approaching vehicle. In some embodiments, the apparatus 200 stores the predicted landing distance at the data store 107. For example, the apparatus may store the predicted landing distance in association with an identifier of the approaching vehicle, the runway model, and/or the like.

At operation 421, the apparatus 200 includes means such as the prediction circuitry 209, the communications circuitry 205, the input/output circuitry 207, the processor 201, and/or the like, or a combination thereof, that provide the predicted landing distance for the approaching vehicle, the one or more historical true landing distances, and the one or more historical predicted landing distances to the approaching vehicle. For example, the apparatus 200 may provide the predicted landing distance and historical true and predicted landing distances to the approaching vehicle via one or more networks 150. Additionally, in some embodiments, the apparatus 200 provides the one or more runway conditions to the approaching vehicle. In some embodiments, in performance of operation 421, the apparatus 200 causes the approaching to perform operations 424, 427, 430, and/or 436. For example, the apparatus 200 may cause the approaching vehicle 101 to generate a compensation factor (operation 424), generate a second predicted landing distance based on real-time vehicle data (operation 427), generate a weighted predicted landing distance (operation 430), and/or the like. The apparatus 200 may further cause the vehicle to be controlled (e.g., by a vehicle operator, autopilot, and/or the like) based at least in part the weighted landing distance, the one or more runway conditions, and/or the like (operation 436).

At operation 424, the approaching vehicle includes means such as the vehicle management system that generate a compensation factor based at least in part on the historical predicted landing distances and associated historical true landing distances for the one or more vehicles. For example, the vehicle management system 115 of the approaching vehicle 101 may generate a compensation factor 123 based at least in part on respective differences between the historical predicted and historical true landing distances for one or more vehicles previously landed upon the runway. In some embodiments, the approaching vehicle 101 renders the compensation factor, the historical predicted landing distances, the historical true landing distances, the one or more runway conditions, and/or the like on one or more displays associated with the vehicle management system.

At operation 427, the approaching vehicle includes means such as the vehicle management system that generate a second predicted landing distance for the approaching vehicle based at least in part on real-time vehicle data. For example, the vehicle management system 115 may generate a second predicted landing distance based at least in part on the real-time vehicle data of operation 409, additional real-time vehicle data generate subsequent to operation 409, and/or the like. In some embodiments, the vehicle management system generates the second predicted landing distanced further based at least in part on one or more runway conditions received from the apparatus 200.

At operation 430, the approaching vehicle includes means such as the vehicle management system that generate a weighted landing distance based at least in part on the compensation factor, the first predicted landing distance generated by the apparatus 200, and the second predicted landing distance generated by the vehicle management system. For example, the vehicle management system 115 may generate a weighted average of the first predicted landing and the second predicted landing distance based at least in part on the compensation factor. In some embodiments, the vehicle management system applies the compensation factor to the first predicted landing distance to generate a compensated landing distance prediction and generates the weighted landing distanced based on the compensated landing distance prediction and the second predicted landing distance. The weighted predicted landing distance may be less than, greater than, or equal to either of the first or second predicted landing distances based on the compensation factor.

At operation 433, the apparatus 200 includes optionally means such as the prediction circuitry 209, the communications circuitry 205, the input/output circuitry 207, the processor 201, and/or the like, or a combination thereof, that obtain the weighted landing distance from the approaching vehicle. For example, the apparatus 200 may receive the weighted landing distance from the vehicle management system 115 via one or more networks 150. Additionally, in some embodiments, the apparatus 200 obtains the compensation factor, the second predicted landing distance, and/or the like from the approaching vehicle. In some embodiments, the apparatus 200 stores the weighted landing distance, compensation factor, second predicted landing distance, and/or the like in association with the first predicted landing distance, the runway model, information identifying the approaching vehicle, and/or the like. In some embodiments, the apparatus 200 renders the weighted landing distance, compensation factor, second predicted landing distance, and/or the like on one or more displays such that a ground station operator may observe the landing prediction information.

At operation 436, the apparatus 200 optionally includes means such as the prediction circuitry 209, the communications circuitry 205, the input/output circuitry 207, the processor 201, and/or the like, or a combination thereof, that cause the approaching vehicle to be controlled based at least in part on the weighted landing distance. For example, the apparatus 200 may cause an operator of the approaching vehicle, an autopilot function of the approaching vehicle, and/or the like, to land the vehicle upon the runway based at least in part on the weighted landing distance. In some embodiments, the apparatus 200, the vehicle management system 115, the vehicle operator, and/or the like may generate one or more landing parameters based at least in part on the weighted landing distance. For example, the landing parameters may include descent rate, thrust, speed, nose angle, braking, flap orientation, and/or the like.

In some embodiments, the apparatus 200 instructs and/or causes the approaching vehicle to land on an alternative runway based at least in part on the weighted landing distance. For example, the apparatus 200 may determine that the weighted landing distance exceeds a predetermined landing threshold for the runway based at least in part on a comparison between the weighted landing distance and one or more predetermined thresholds, such as runway length, landing distance safety factor, vehicle speed, vehicle braking capability, and/or the like. In some embodiments, the apparatus 200 determines an alternative runway upon which the approaching vehicle may land. The apparatus 200 may communicate the alternative runway to the vehicle management system of the approaching vehicle using one or more networks. In some embodiments, the apparatus 200 determines that the approaching vehicle cannot safely land on the runway based at least in part on the weighted landing distance. In some embodiments, in response to the determination, the apparatus 200 instructs the approaching vehicle to land at a different location, enter a holding pattern, and/or the like.

At operation 439, the apparatus 200 optionally includes means such as the prediction circuitry 209, the communications circuitry 205, the input/output circuitry 207, the processor 201, and/or the like, or a combination thereof, that obtain a true landing distance for the approaching vehicle following landing. For example, the apparatus 200 may receive the true landing distance from the vehicle management system 115 of the vehicle 101. As another example, the apparatus 200 may generate the true landing distance of the vehicle 101 based at least in part on sensor data 106 from one or more sensors 105, such as one or more radar arrays, motion sensors, velocity measurement devices, and/or the like.

At operation 442, the apparatus 200 optionally includes means such as the prediction circuitry 209, the communications circuitry 205, the input/output circuitry 207, the processor 201, and/or the like, or a combination thereof, that store the true landing distance. For example, the apparatus 200 may store the true landing distance at the data store 107. In some embodiments, the apparatus 200 stores the true landing distance in association with the predicted landing distance of operation 418, the runway model, the one or more runway conditions, and/or the like. In some embodiments, the apparatus 200 stores the true landing distance in association with one or more vehicle classifications of the approaching vehicle and the runway upon which the vehicle landed. Additionally, in some embodiments, the apparatus 200 stores a landing speed, braking rate, landing angle, and/or the like of the vehicle.

At operation 445, the apparatus 200 optionally includes means such as the prediction circuitry 209, the communications circuitry 205, the input/output circuitry 207, the processor 201, and/or the like, or a combination thereof, that update the runway model of operation 415 based at least in part on data associated with landing of the vehicle. For example, the apparatus 200 may update the runway model 109 based at least in part on the true landing distance of the vehicle. In doing so, the apparatus 200 may improve accuracy of the runway model 109 in generating subsequent landing distance predictions for the runway, the landed vehicle, vehicles sharing one or more classifications of the vehicle, and/or the like.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method to improve landing distance prediction, comprising:
generating, at a ground station, at least one runway condition associated with a runway based at least in part on sensor data from at least one sensor;
retrieving, at the ground station, one of a plurality of stored runway models based at least in part on the at least one runway condition;
generating, at the ground station and using the retrieved runway model, a predicted landing distance for an approaching vehicle upon the runway based at least in part on model input comprising real-time vehicle data for the approaching vehicle; and
providing, from the ground station to the approaching vehicle, a historical true landing distance for at least one vehicle, a historical predicted landing distance for the at least one vehicle, and the predicted landing distance for the approaching vehicle to cause the approaching vehicle to:
generate a compensation factor based at least in part on the historical true landing distance for the at least one vehicle and the historical predicted landing distance for the at least one vehicle;
generate a second predicted landing distance for the approaching vehicle based at least in part on the real-time vehicle data for the approaching vehicle; and
generate a weighted landing distance based at least in part on the predicted landing distance for the approaching vehicle, the second predicted landing distance, and the compensation factor.

2. The method of claim 1, further comprising:
obtaining, at the ground station, a true landing distance of the approaching vehicle upon the runway; and
storing, at the ground station, the true landing distance of the approaching vehicle in association with the predicted landing distance for the approaching vehicle.

3. The method of claim 2, wherein:
the ground station receives the true landing distance of the approaching vehicle from the approaching vehicle.

4. The method of claim 2, further comprising:
receiving, at the ground station, additional real-time vehicle data for the approaching vehicle during landing, wherein the ground station generates the true landing of the approaching vehicle based at least in part on the additional real-time vehicle data.

5. The method of claim 1, further comprising:
receiving, at the ground station, the real-time vehicle data for the approaching vehicle from at least one flight monitoring system of the approaching vehicle.

6. The method of claim 1, further comprising:
obtaining, at the ground station, the historical true landing distance for the at least one vehicle; and
storing, at the ground station, the historical true landing distance in association with the historical predicted landing distance for the at least one vehicle upon the runway.

7. The method of claim 6, further comprising:
determining at least one classification of the approaching vehicle matches at least one classification of the at least one vehicle; and
in response to the determination, providing the historical true landing distance and the historical predicted distance for the at least one vehicle to the approaching vehicle.

8. The method of claim 1, wherein:
a respective true landing distance corresponds to a length of a runway used by a vehicle to land upon the runway; and
the historical true landing distance is obtained by the ground station from the at least one vehicle.

9. The method of claim 1, further comprising:
causing an autopilot system of the approaching vehicle to control the approaching vehicle based at least in part on at least one of the compensation factor or the weighted landing distance.

10. An apparatus comprising at least one processor and at least one non-transitory memory having computer-coded instructions stored thereon that, in execution with at least one processor, cause the apparatus to:
generate, at a ground station, at least one runway condition associated with a runway based at least in part on sensor data from at least one sensor;
retrieve, at the ground station, one of a plurality of stored runway models based at least in part on the at least one runway condition;
generate, at the ground station and using the retrieved runway model, a predicted landing distance for an approaching vehicle upon the runway based at least in part on model input comprising real-time vehicle data for the approaching vehicle; and
provide, from the ground station to the approaching vehicle, a historical true landing distance for at least one vehicle, a historical predicted landing distance for the at least one vehicle, and the predicted landing distance for the approaching vehicle to cause the approaching vehicle to:
generate a compensation factor based at least in part on the historical true landing distance for the at least one vehicle and the historical predicted landing distance for the at least one vehicle;
generate a second predicted landing distance for the approaching vehicle based at least in part on the real-time vehicle data for the approaching vehicle; and
generate a weighted landing distance based at least in part on the predicted landing distance for the approaching vehicle, the second predicted landing distance, and the compensation factor.

11. The apparatus of claim 10, wherein:
the at least one runway condition comprises at least one precipitation condition associated with the runway.

12. The apparatus of claim 11, wherein:
the at least one precipitation condition comprises at least one of snow, ice, or frost.

13. The apparatus of claim 10, wherein:
the at least one precipitation condition comprises snow compaction.

14. The apparatus of claim 10, wherein:
the at least one runway condition comprises at least one wind condition associated with the runway.

15. The apparatus of claim 10, wherein:
the at least one runway condition comprises runway visual range.

16. The apparatus of claim 10, wherein:
the at least one runway condition comprises runway elevation.

17. The apparatus of claim 10, wherein:
the computer-coded instructions, in execution with the at least one processor, further cause the apparatus to:
receive at least one of the compensation factor, the weighted landing distance, or a true landing distance from the approaching vehicle; and
store at least one of the compensation factor, the weighted landing distance, or the true landing distance in association with at least one of the historical predicted landing distance for the at least one vehicle or the predicted landing distance for the at least one vehicle.

18. The apparatus of claim 17, wherein:
the computer-coded instructions, in execution with the at least one processor, further cause the apparatus to:
update a respective runway model based at least in part on at least one of the compensation factor, the weighted landing distance, or the true landing distance.

19. The apparatus of claim 17, wherein:
the computer-coded instructions, in execution with the at least one processor, further cause the apparatus to:
receive the weighted landing distance from the approaching vehicle; and
instruct the approaching vehicle to land on a second runway based at least in part on the weighted landing distance.

20. A computer program product comprising at least one non-transitory computer-readable storage medium having computer program code stored thereon that, in execution with at least one processor, is configured to:
generate, at a ground station, at least one runway condition associated with a runway based at least in part on sensor data from at least one sensor;
retrieve, at the ground station, one of a plurality of stored runway models based at least in part on the at least one runway condition;
generate, at the ground station and using the retrieved runway model, a predicted landing distance for an approaching vehicle upon the runway based at least in part on model input comprising real-time vehicle data for the approaching vehicle; and
provide, from the ground station to the approaching vehicle, a historical true landing distance for at least one vehicle, a historical predicted landing distance for the at least one vehicle, and the predicted landing distance for the approaching vehicle to cause the approaching vehicle to:
generate a compensation factor based at least in part on the historical true landing distance for the at least one vehicle and the historical predicted landing distance for the at least one vehicle;
generate a second predicted landing distance for the approaching vehicle based at least in part on the real-time vehicle data for the approaching vehicle; and
generate a weighted landing distance based at least in part on the predicted landing distance for the approaching vehicle, the second predicted landing distance, and the compensation factor.
